(19) United States
(12) Patent Application Publication
(10) Pub. No.: US 2026/0266694 A1
(43) Pub. Date: Sep. 10, 2026

(54) METHOD AND APPARATUS FOR ESTIMATING SCALE ERROR OF VEHICLE SPEED

(71) Applicants: Hyundai Motor Company, Seoul (KR); Kia Corporation, Seoul (KR)

(72) Inventor: Min Seok Ok, Hwaseong (KR)

(21) Appl. No.: 19/377,947

(22) Filed: Nov. 3, 2025

(30) Foreign Application Priority Data
Mar. 4, 2025 (KR) 10-2025-0027627

(51) Int. Cl. G01M 17/02; G07C 5/02

(52) U.S. Cl. CPC G01M 17/02; G07C 5/02

(57) ABSTRACT

A method and apparatus for estimating a scale error of a vehicle speed are disclosed. The method for estimating a scale error may include estimating first scale errors of tires using wheel speeds of wheels of a vehicle and pressures of the wheels, estimating second scale errors of the tires using the wheel speeds of the wheels, the pressures of the wheels, and inertial measurement unit (IMU) measurement information, determining a third scale error among the first scale errors of the tires using the wheel speeds of the wheels and a fourth scale error among the second scale errors of the tires using the wheel speeds of the wheels, and determining a fifth scale error using the third scale error and the fourth scale error.

### CROSS-REFERENCE TO RELATED APPLICATION

This application claims, under 35 U.S.C. § 119 (a), the benefit of Korean Patent Application No. 10-2025-0027627, filed Mar. 4, 2025, the entire contents of which are incorporated herein by reference.

### BACKGROUND

### (a) Technical Field

The present disclosure relates to a method and apparatus for estimating a scale error of a vehicle speed. More specifically, the present disclosure relates to a method and apparatus for estimating a data-driven scale error, estimating a model-based scale error, and determining a final scale error from each estimated scale error.

### (b) Description of the Related Art

The content described below merely provides background information related to the present embodiments and does not constitute prior art.

In a navigation system that provides location information and route information to a vehicle and guides the vehicle to the destination, it is important to determine an exact location of the vehicle.

Recently, dead reckoning (DR) has been used in combination with a global navigation satellite system (GNSS) as the navigation system. DR uses sensing values acquired from various sensors. DR is a general technology used for positioning and navigation. When a vehicle enters a section where a global positioning system (GPS) signal cannot be received, such as a tunnel or an underground parking lot, DR acquires the vehicle's location, speed, and route data using sensors.

The vehicle speed may be calculated based on a wheel speed and, in this case, a scale error may occur. In DR, the scale error becomes a major source of error in calculating the vehicle's location. Accordingly, it is necessary to estimate the scale error and compensate for the estimated scale error to improve the reliability of DR.

Conventionally, the scale error is estimated by comparing the absolute location and the location by DR using the GPS signals, but in underground parking lots or tunnels, the accuracy of GPS signals is low, so there is a problem that the scale error cannot be accurately estimated. In addition, when the scale error is estimated using a tire pressure, other factors except the tire pressure are not considered, so there is a problem that the scale error cannot be accurately estimated. Accordingly, research is needed to accurately estimate the scale error.

### SUMMARY

An object of the present disclosure is to estimate an accurate scale error by using both a scale error estimated based on data and a scale error estimated based on a model.

In addition, according to one embodiment, an object of the present disclosure is to improve the reliability of the scale error by calculating the reliability of the estimated scale error.

Objects of the present disclosure are not limited to the objects mentioned above, and other objects not mentioned can be clearly understood by those skilled in the art from the description below.

According to at least one embodiment, the present disclosure provides a scale error estimation apparatus. The scale error estimation apparatus comprises: a data-driven scale error estimation unit for estimating first scale errors of tires using wheel speeds of wheels of a vehicle and pressures of the wheels, a model-based scale error estimation unit for estimating second scale errors of the tires using the wheel speeds of the wheels, the pressures of the wheels, and inertial measurement unit (IMU) measurement information, a scale error determination unit for determining a third scale error among the first scale errors of the tires using the wheel speeds of the wheels, a fourth scale error among the second scale errors of the tires using the wheel speeds of the wheels, and a fifth scale error using the third scale error and the fourth scale error; and a reliability calculation unit for calculating reliability of the fifth scale error using a difference between the third scale error and the fourth scale error and acceleration of the vehicle.

According to another embodiment, the present disclosure provides a method for estimating a scale error. The method comprises: estimating first scale errors of tires using wheel speeds of wheels of a vehicle and pressures of the wheels, estimating second scale errors of the tires using the wheel speeds of the wheels, the pressures of the wheels, and inertial measurement unit (IMU) measurement information, determining a third scale error among the first scale errors of the tires using the wheel speeds of the wheels and a fourth scale error among the second scale errors of the tires using the wheel speeds of the wheels, determining a fifth scale error using the third scale error and the fourth scale error and calculating reliability of the fifth scale error using a difference between the third scale error and the fourth scale error and acceleration of the vehicle.

A computer-readable recording medium storing instructions, wherein the instructions, when executed by a computer, cause the computer to perform: estimating first scale errors of tires using wheel speeds of wheels of a vehicle and pressures of the wheels, estimating second scale errors of the tires using the wheel speeds of the wheels, the pressures of the wheels, and inertial measurement unit (IMU) measurement information, determining a third scale error among the first scale errors of the tires using the wheel speeds of the wheels and a fourth scale error among the second scale errors of the tires using the wheel speeds of the wheels, determining a fifth scale error using the third scale error and the fourth scale error and calculating reliability of the fifth scale error using a difference between the third scale error and the fourth scale error and acceleration of the vehicle.

According to the present disclosure, there is an effect of estimating an accurate and highly reliable scale error and compensating for the estimated scale error to improve the accuracy of the location determined by the dead reckoning.

In addition, according to one embodiment, there is an effect of estimating the scale error using only the sensing values of sensors inside a vehicle without using external signals such as GPS signals.

In addition, according to one embodiment, there is an effect of estimating the scale error in real time and compensating for the scale error.

According to an aspect of the present disclosure, a scale error estimation apparatus is provided. The scale error estimation apparatus may comprise a computing device, comprising a processor and a memory. The memory may be configured to store instructions that, when executed by the processor, are configured to cause the processor to estimate first scale errors of tires using wheel speeds of wheels of a vehicle and pressures of the wheels, estimate second scale errors of the tires using the wheel speeds of the wheels, the pressures of the wheels, and inertial measurement unit (IMU) measurement information, determine a third scale error among the first scale errors of the tires using the wheel speeds of the wheels, a fourth scale error among the second scale errors of the tires using the wheel speeds of the wheels, and a fifth scale error using the third scale error and the fourth scale error, and calculate a reliability of the fifth scale error using a difference between the third scale error and the fourth scale error and acceleration of the vehicle.

According to an exemplary embodiment, the computing device may be further configured to estimate the first scale errors of the tires using a lookup table.

According to an exemplary embodiment, the lookup table may comprise predetermined data on the wheel speeds of the wheels and the pressures of the wheels.

According to an exemplary embodiment, the computing device may be further configured to calculate rotational influences of the tires using the wheel speeds of the wheels and parameters of the tires and calculate a vertical stiffness of the tires using the pressures of the wheels and the parameters of the tires.

According to an exemplary embodiment, the computing device may be further configured to calculate a vertical force of the tires using the IMU measurement information and specification information of the vehicle.

According to an exemplary embodiment, the computing device may be further configured to calculate a first tire effective radiuss using the rotational influences of the tires, the vertical stiffness of the tires, the vertical forces of the tires, the parameters of the tires, and the specification information of the vehicle.

According to an exemplary embodiment, the computing device may be further configured to calculate the second scale error of the tires using the first tire effective radiuss and a second tire effective radiuss obtained by electronic stability control (ESC).

According to an exemplary embodiment, the computing device may be further configured to calculate a gain using the acceleration of the vehicle, a first threshold value, and a second threshold value, and determine the fifth scale error using the third scale error and the fourth scale error based on the gain.

According to an exemplary embodiment, the first threshold value and the second threshold value may be predetermined arbitrary values.

According to an exemplary embodiment, the first threshold value may be smaller than the second threshold value.

According to an exemplary embodiment, the computing device may be further configured to calculate the gain as 0 when the acceleration of the vehicle is smaller than or equal to the first threshold value, calculate the gain linearly when the acceleration of the vehicle is greater than the first threshold value and smaller than the second threshold value, and calculate the gain as 1 when the acceleration of the vehicle is greater than or equal to the second threshold value.

According to an aspect of the present disclosure, a method performed by a scale error estimation apparatus is provided. The method may comprise, using a computing device comprising a processor and a memory, estimating first scale errors of tires using wheel speeds of wheels of a vehicle and pressures of the wheels, estimating second scale errors of the tires using the wheel speeds of the wheels, the pressures of the wheels, and inertial measurement unit (IMU) measurement information, determining a third scale error among the first scale errors of the tires using the wheel speeds of the wheels, a fourth scale error among the second scale errors of the tires using the wheel speeds of the wheels, and a fifth scale error using the third scale error and the fourth scale error, and calculating a reliability of the fifth scale error using a difference between the third scale error and the fourth scale error and acceleration of the vehicle.

According to an exemplary embodiment, the estimating the first scale errors of the tires may comprise estimating the first scale errors of the tires using a lookup table.

According to an exemplary embodiment, the lookup table may comprise predetermined data on the wheel speeds of the wheels and the pressures of the wheels.

According to an exemplary embodiment, the estimating the second scale errors of the tires may comprise calculating rotational influences of the tires using the wheel speeds of the wheels and parameters of the tires and calculating a vertical stiffness of the tires using the pressures of the wheels and the parameters of the tires.

According to an exemplary embodiment, the estimating the second scale errors of the tires may comprise calculating a vertical force of the tires using the IMU measurement information and specification information of the vehicle.

According to an exemplary embodiment, the estimating the second scale errors of the tires may comprise calculating a first tire effective radiuss using the rotational influences of the tires, the vertical stiffness of the tires, the vertical forces of the tires, the parameters of the tires, and the specification information of the vehicle and calculating the second scale errors of the tires using the first tire effective radiuss and a second tire effective radiuss obtained by electronic stability control (ESC).

According to an exemplary embodiment, the determining the fifth scale error may comprise calculating a gain using the acceleration of the vehicle, a first threshold value, and a second threshold value and determining the fifth scale error using the third scale error and the fourth scale error based on the gain.

According to an exemplary embodiment, the first threshold value and the second threshold value may be predetermined arbitrary values.

According to an exemplary embodiment, the first threshold value may be smaller than the second threshold value.

According to an exemplary embodiment, the gain may be calculated as 0 when the acceleration of the vehicle is smaller than or equal to the first threshold value, the gain may be calculated linearly when the acceleration of the vehicle is greater than the first threshold value and smaller than the second threshold value, and the gain may be calculated as 1 when the acceleration of the vehicle is greater than or equal to the second threshold value.

According to an aspect of the present disclosure, a scale error estimation apparatus is provided. The scale error estimation apparatus may comprise a vehicle and a computing device, coupled to the vehicle, comprising a processor and a memory. The memory may be configured to store instructions that, when executed by the processor, are configured to cause the processor to estimate first scale errors of tires using wheel speeds of wheels of the vehicle and pressures of the wheels, estimate second scale errors of the tires using the wheel speeds of the wheels, the pressures of the wheels, and inertial measurement unit (IMU) measurement information, determine a third scale error among the first scale errors of the tires using the wheel speeds of the wheels, a fourth scale error among the second scale errors of the tires using the wheel speeds of the wheels, and a fifth scale error using the third scale error and the fourth scale error, and calculate a reliability of the fifth scale error using a difference between the third scale error and the fourth scale error and acceleration of the vehicle.

Effects obtainable from the present disclosure are not limited to the effects mentioned above, and other effects not mentioned can be clearly understood by those skilled in the art to which the present disclosure belongs from the description below.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a block diagram for explaining an apparatus for estimating a scale error of a vehicle speed, according to an exemplary embodiment of the present disclosure.

FIG. 2 illustrates a block diagram illustrating a model-based scale error estimation unit, according to an exemplary embodiment of the present disclosure.

FIG. 3 illustrates a diagram illustrating a relationship between acceleration of a vehicle and gain, according to an exemplary embodiment of the present disclosure.

FIG. 4 illustrates a diagram illustrating reliability of the scale error according to a difference between the acceleration of the vehicle and a scale error, according to an exemplary embodiment of the present disclosure.

FIGS. 5A and 5B illustrate diagrams illustrating the scale error over time and a difference in dependency with respect to a reference vehicle before compensation and a difference in dependency with respect to a reference vehicle after compensation over time, according to exemplary embodiments of the present disclosure.

FIGS. 6A, 6B, and 6C illustrate diagrams illustrating a trajectory of a vehicle before compensation and a trajectory of a vehicle after compensation, a distance error before compensation and a distance error after compensation over time, and a speed error before compensation and a speed error after compensation over time, according to exemplary embodiments of the present disclosure.

FIG. 7 illustrates a flowchart illustrating a method for estimating a scale error of a vehicle speed, according to an exemplary embodiment of the present disclosure.

FIG. 8 illustrates a block diagram schematically illustrating an exemplary computing device that may be used to implement a method, according to an exemplary embodiment of the present disclosure.

FIG. 9 illustrates an example architecture of a vehicle, according to an exemplary embodiment of the present disclosure.

### DETAILED DESCRIPTION

Hereinafter, some embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein has been omitted for the purpose of clarity and for brevity.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well-known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

It will be understood that, although the terms “first”, “second”, etc. may be used herein to describe various elements, these elements should not be limited by these terms. These terms are only used to distinguish one element from another.

The suffixes “module” and “unit” of elements herein are used for convenience of description and thus may be used interchangeably and do not have any distinguishable meanings or functions.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Any number of components or a variety of components of any one of the configurations disclosed in the present disclosure may be included in the present disclosure. Such components may include any combination of characterized parts disclosed in the present disclosure, and may be arranged to constitute any one of various configurations disclosed in the present disclosure. Not only structures and arrangements of the components of the present disclosure, but also concepts as to use and operation thereof, may be applied not only to particular embodiments discussed in the present disclosure, but also to embodiments of any numbers and in any combinations. In the following description, embodiments including various characterized parts having various arrangements will be described with reference to the accompanying drawings.

Additionally, various terms such as first, second, A, B, (a), (b), and the like, are used solely to differentiate one component from another but not to imply or suggest the substance, order, or sequence of the components. Throughout this specification, when a part ‘has’, ‘includes’, or ‘comprises’ a component, the part is meant to further include other components, not to exclude other components unless specifically stated to the contrary. The terms such as ‘unit’, ‘module’, and the like refer to one or more units for processing at least one function or operation, which may be implemented by hardware, software, or a combination thereof. When a component, unit, module, controller, device, element, apparatus, or the like of the present disclosure is described as having a purpose or performing an operation, function, or the like, the component, unit, module, controller, device, element, apparatus, or the like should be considered herein as being “configured to” meet that purpose or to perform that operation or function. Each component, unit, module, controller, device, element, apparatus, and the like may separately embody or be included with a processor and a memory, such as a non-transitory computer readable media, as part of the apparatus.

The following detailed description, together with the accompanying drawings, is intended to describe embodiments of the present disclosure, and is not intended to represent the only embodiments by which the present disclosure may be practiced.

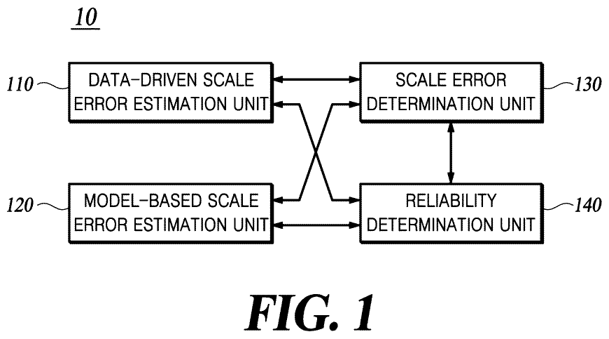

Referring now to FIG. 1, a block diagram for explaining an apparatus for estimating a scale error of a vehicle speed is illustratively depicted, in accordance with an exemplary embodiment of the present disclosure.

Referring to FIG. 1, an apparatus for estimating a scale error of a vehicle speed (hereinafter, referred to as a “scale error estimation apparatus”, 10) may comprise all or some of a data-driven scale error estimation unit 110, a model-based scale error estimation unit 120, a scale error determination unit 130, and a reliability determination unit 140. The scale error estimation apparatus 10 and each component thereof may be implemented as hardware or software, or may be implemented as a combination of hardware and software. In addition, the function of each component may be implemented as software, and one or more processors may be implemented to execute a function of the software corresponding to each component.

The data-driven scale error estimation unit 110 may be configured to estimate a scale error for each wheel using the wheel speeds and the pressure of the tires for the wheels of the vehicle. Hereinafter, tire and wheel may be used interchangeably. Here, the wheel speed and the pressure of the tires may be sensed by a sensor inside the vehicle and, in particular, the pressure of the tires may be sensed by a tire pressure monitoring system (TPMS). The data-driven scale error estimation unit 110 may be configured to estimate the scale error for each wheel using a look-up table for the wheel speed and the pressure of the tires for the wheels of the vehicle. The look-up table may may comprise pre-learned data. The pre-learned data may comprise data including the pressures of four tires and four wheel speeds, and the data between each section may be in a linear relationship. Since the data between each section is in a linear relationship, the scale error for each wheel may be estimated using linear interpolation.

The model-based scale error estimation unit 120 may be configured to estimate the scale error for each wheel and the tire effective radius in real time based on the tire magic formula model of Pacejka using the wheel speed of the wheels of the vehicle, the pressure of the tires, the measurement information of an inertial measurement unit (IMU), or the like. The measurement information of the IMU may comprise information on the acceleration, direction, angular velocity, and gravity of the vehicle. The tire magic formula model of Pacejka is a model used to mathematically model the complex interaction between the tire and the ground in the dynamics of the vehicle.

The scale error determination unit 130 may be configured to determine which wheel's scale error is the most appropriate by using the scale error of each wheel estimated by the data-driven scale error estimation unit 110 and the scale error of each wheel estimated by the model-based scale error estimation unit 120. The scale error determination unit 130 may be configured to determine the final vehicle speed scale error by combining the determined wheel's scale error estimated by the data-driven scale error estimation unit 110 and the determined wheel's scale error estimated by the model-based scale error estimation unit 120.

The reliability calculation unit 140 may be configured to calculate the reliabilities of the scale error of each wheel estimated by the data-driven scale error estimation unit 110, the scale error of each wheel estimated by the model-based scale error estimation unit 120, and the scale error by estimated using the longitudinal acceleration and lateral acceleration of the vehicle. Here, the calculated reliability may be composed of a total of five levels.

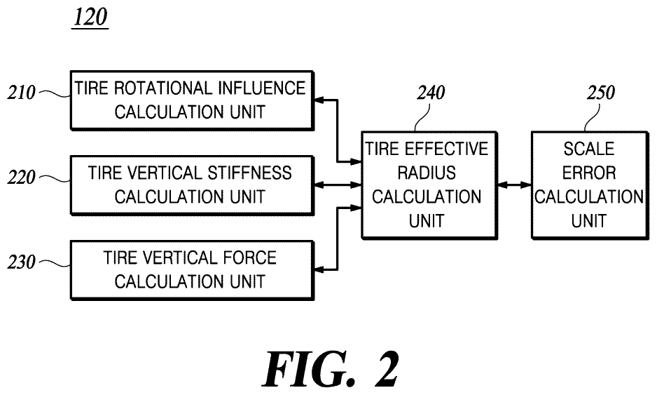

Referring now to FIG. 2, a block diagram illustrating the model-based scale error estimation unit is illustratively depicted, in accordance with an exemplary embodiment of the present disclosure.

The model-based scale error estimation unit 120 may comprise all or some of a tire rotational influence calculation unit 210, a tire vertical stiffness calculation unit 220, a tire vertical force calculation unit 230, a tire effective radius calculation unit 240, and a scale error calculation unit 250. The model-based scale error estimation unit 120 and each component thereof may be implemented as hardware or software, or may be implemented as a combination of hardware and software. In addition, the function of each component may be implemented as software, and one or more processors may be implemented to execute the function of the software corresponding to each component.

The tire rotational influence calculation unit 210 may be configured to calculate the rotational influence of the tires using the parameters for the wheel speed of each wheel of the vehicle and the radius of the tire. The parameters for the radius of the tires may be received by a brake controller. The rotational influence of the tires can be calculated using the following Equation 1.

$${R}_{Ω} = {R}_{0} ( {q}_{re 0} + {{q}_{v 1} ( \frac{Ω {R}_{0}}{{V}_{0}} )}^{2} ) \qquad Equation 1$$

Here, R_{Ω} is a rotational influence of the tire, and R₀ is a tire specification radius. The tire specification radius is a tire radius when no force is applied to the tire. qᵣₑ₀ is an influence coefficient of a tire effective radius according to the tire specification radius, qᵥ₁ is the influence coefficient of the tire effective radius according to the wheel speed, Ω is an angular velocity of the wheel, and V₀ is a reference speed for calculating a speed influence of the tire effective radius.

The tire vertical stiffness calculation unit 220 may be configured to calculate the vertical stiffness of the tires using the pressure of each wheel. The vertical stiffness of the tires may be calculated using the following Equation 2.

$${c}_{z} = {c}_{z 0} \{ 1 + {p}_{Fz 1} ( \frac{p - {p}_{nominal}}{{p}_{nominal}} ) \} \qquad Equation 2$$

Here, c_{z} is the vertical stiffness of the tire, c_{z0} is a reference value of the vertical stiffness of the tire. p_{Fz1} is an influence coefficient of the tire effective radius according to the pressure of the wheel, pₙₒₘᵢₙₐₗ is the reference pressure for calculating a pressure influence of the tire effective radius, and p is the pressure of the wheel.

The tire vertical force calculation unit 230 may be configured to calculate the vertical force of each tire using the IMU measurement information, vehicle specification information, or the like. The vertical force of each tire may be calculated using the following Equation 3, Equation 4, Equation 5, and Equation 6.

$${F}_{z , FL} = \{ \frac{{a}_{y} h}{{T}_{f}} + \frac{{gl}_{r} + {a}_{x} h}{2 ( {l}_{f} + {l}_{r} )} \} , M , {F}_{z 0 , FL} = \frac{{Mgl}_{r}}{2 ( {l}_{f} + {l}_{r} )} \qquad Equation 3$$

Here, F_{z,FL} is the vertical force of the front left tire of the vehicle, F_{z0,FL} is the vertical force of the front left tire of the vehicle in static equilibrium. a_{y} is the lateral acceleration of the vehicle, h is the height from the ground to the center of the vehicle, T_{f} is the distance between the left and right tires of the vehicle, and g is the acceleration of gravity. Iᵣ is the distance between the rear tire and the vertical projection of the center of the vehicle, aₓ is the longitudinal acceleration of the vehicle, I_{f} is the distance between the front tire and the vertical projection of the center of the vehicle, and M is the mass of the vehicle.

$${F}_{z , FR} = \{ - \frac{{a}_{y} h}{{T}_{f}} + \frac{{gl}_{r} + {a}_{x} h}{2 ( {l}_{f} + {l}_{r} )} \} M , {F}_{z 0 , FR} = \frac{{Mgl}_{r}}{2 ( {l}_{f} + {l}_{r} )} \qquad Equation 4$$

Here, F_{z,FR} is the vertical force on the front right tire of the vehicle, and F_{z0,FR} is the vertical force on the front right tire of the vehicle in static equilibrium. a_{y} is the lateral acceleration of the vehicle, h is the height from the ground to the center of the vehicle, T_{f} is the distance between the left and right tires of the vehicle, and g is the acceleration of gravity. Iᵣ is the distance between the rear tire and the vertical projection of the center of the vehicle, aₓ is the longitudinal acceleration of the vehicle, I_{f} is the distance between the front tire and the vertical projection of the center of the vehicle, and M is the mass of the vehicle.

$${F}_{z , RL} = \{ \frac{{a}_{y} h}{{T}_{r}} + \frac{{gl}_{f} - {a}_{x} h}{2 ( {l}_{f} + {l}_{r} )} \} M , {F}_{z 0 , RL} = \frac{{Mgl}_{f}}{2 ( {l}_{f} + {l}_{r} )} \qquad Equation 5$$

Here, F_{z,RL} is the vertical force on the rear left tire of the vehicle, and F_{z0,RL} is the vertical force on the rear left tire of the vehicle in static equilibrium. a_{y} is the lateral acceleration of the vehicle, h is the height from the ground to the center of the vehicle, Tᵣ is the distance between the left and right tires of the vehicle, and g is the acceleration of gravity. Iᵣ is the distance between the rear tire and the vertical projection of the center of the vehicle, aₓ is the longitudinal acceleration of the vehicle, I_{f} is the distance between the front tire and the vertical projection of the center of the vehicle, and M is the mass of the vehicle.

$${F}_{z , RR} = \{ - \frac{{a}_{y} h}{{T}_{r}} + \frac{{gl}_{f} - {a}_{x} h}{2 ( {l}_{f} + {l}_{r} )} \} M , {F}_{z 0 , RR} = \frac{{Mgl}_{f}}{2 ( {l}_{f} + {l}_{r} )} \qquad Equation 6$$

Here, F_{z,RR} is the vertical force on the rear right tire of the vehicle, and F_{z0,RR} is the vertical force on the rear right tire of the vehicle in static equilibrium. a_{y} is the lateral acceleration of the vehicle, h is the height from the ground to the center of the vehicle, Tᵣ is the distance between the left and right tires of the vehicle, and g is the acceleration of gravity. Iᵣ is the distance between the rear tire and the vertical projection of the center of the vehicle, aₓ is the longitudinal acceleration of the vehicle, I_{f} is the distance between the front tire and the vertical projection of the center of the vehicle, and M is the mass of the vehicle.

The tire effective radius calculation unit 240 may be configured to calculate the effective radius of each tire using the tire rotational influence calculated by the tire rotational influence calculation unit 210, the tire vertical stiffness calculated by the tire vertical stiffness calculation unit 220, the vertical force of each tire calculated by the tire vertical force calculation unit 230, or the like. The effective radius of each tire may be calculated using the following Equation 7.

$${R}_{e} = {R}_{Ω} - \frac{{F}_{z 0}}{{C}_{z}} ( {D}_{reff} acrtan ( {B}_{reff} \frac{{F}_{z}}{{F}_{z 0}} ) + {F}_{reff} \frac{{F}_{z}}{{F}_{z 0}} ) \qquad Equation 7$$

Here, Rₑ is the effective radius of each tire, R_{Ω} is the rotational influence of each tire, F_{z0} is the vertical force of each tire in static equilibrium, and C_{z} is the vertical stiffness of each tire. D_{reff} is a coefficient related to the peak value of the tire effective radius, B_{reff} is the influence coefficient of the tire effective radius according to the load in the low load region, F_{z} is the normal force of each tire, and F_{reff} is the influence coefficient of the tire effective radius according to the load in the high load region.

The scale error calculation unit 250 may be configured to calculate the scale error of each tire using the effective radius of each tire calculated by the tire effective radius calculation unit 240. The scale error of each tire may be calculated using the following Equation 8.

$$ScaleFactor ( model ) = {R}_{e} / {R}_{ESC} \qquad Equation 8$$

Here, ScaleFactor(model) is the scale error of each tire. ScaleFactor(model) may be the scale error estimated by the model-based scale error estimation unit 120. Rₑ is the effective radius of each tire calculated by the tire effective radius calculation unit 240, and R_{ESC} is the effective radius of each tire obtained by electronic stability control (ESC).

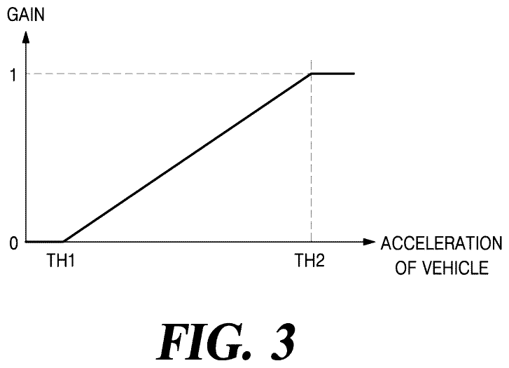

Referring now to FIG. 3, a diagram illustrating a relationship between acceleration of the vehicle and gain is illustratively depicted, in accordance with an exemplary embodiment of the present disclosure. The scale error determination unit 130 may be configured to determine a final data-driven tire scale error among the scale errors of each tire estimated by the data-driven scale error estimation unit 110. The scale error determination unit 130 may be configured to determine a final model-based tire scale error among the scale errors of each tire estimated by the model-based scale error estimation unit 120.

The final data-driven tire scale error and the final model-based tire scale error may be determined based on the tire having the closest wheel speed to the current vehicle dependency. Alternatively, when the vehicle's brakes are on, the final data-driven tire scale error and the final model-based tire scale error may be determined based on the tire having the maximum wheel speed. Alternatively, when the vehicle's brakes are off, the final data-driven tire scale error and the final model-based tire scale error may be determined based on the tire having the minimum wheel speed.

The scale error determination unit 130 may be configured to determine the final tire scale error using the final data-driven tire scale error and the final model-based tire scale error and gain. The final tire scale error may be calculated using the following Equation 9.

$${SF}_{Final} = ( 1 - Gain ) {SF}_{Data} + Gain \cdot {SF}_{Model} \qquad Equation 9$$

Here, SF_{Final} is the final tire scale error. SF_{Data} is the final data-driven tire scale error, and SF_{Model} is the final model-based tire scale error.

Referring to FIG. 3, the relationship between the gain and the acceleration of the vehicle may be confirmed. The acceleration of the vehicle may be calculated using the longitudinal acceleration of the vehicle and the lateral acceleration of the vehicle. The acceleration of the vehicle is the square root of the sum of the longitudinal acceleration of the vehicle squared and the lateral acceleration of the vehicle squared. When the acceleration of the vehicle is smaller than a first threshold value TH1, the gain may be 0. When the acceleration of the vehicle is greater than the first threshold value TH1 and smaller than a second threshold value TH2, the gain may have a value between 0 and 1. In this case, the gain may be a value obtained by dividing the acceleration of the vehicle by the value obtained by subtracting the first threshold value TH1 from the second threshold value TH2. When the acceleration of the vehicle is greater than the second threshold value TH2, the gain may be 1. Here, the first threshold value TH1 and the second threshold value TH2 may be any predefined values.

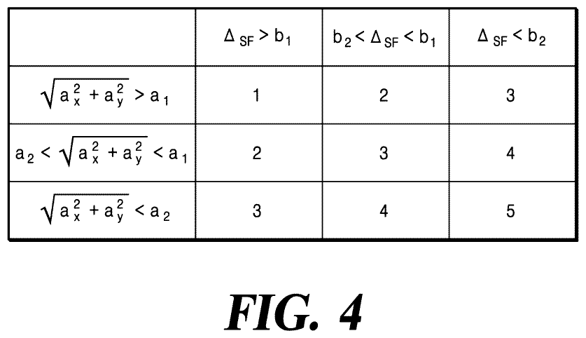

Referring now to FIG. 4, a diagram illustrating the reliability of the scale error according to the difference between the acceleration of the vehicle and the scale error is illustratively depicted, in accordance with an exemplary embodiment of the present disclosure.

Referring to FIG. 4, the reliability calculation unit 140 may be configured to calculate the reliability of the scale error by using the final data-driven tire scale error and the final model-based tire scale error calculated by the scale error determination unit 130 and the acceleration of the vehicle. The larger the difference between the final data-driven tire scale error and the final model-based tire scale error, the lower the reliability of the scale error, and the larger the acceleration of the vehicle, the lower the reliability of the scale error. When the wheel is in a slipping or locked state, the reliability of the scale error has the lowest value, and when none of the information sensed by the TPMS is received, the reliability of the scale error may have the lowest value.

Δ_{SF} is the absolute value of the difference between the final data-driven tire scale error and the final model-based tire scale error. a₁, a₂, b₁, and b₂ are threshold values that separate the sections and may be any predefined values. aₓ is the longitudinal acceleration of the vehicle, and a_{y} is the lateral acceleration of the vehicle.

When the vehicle acceleration is greater than a₁ and Δ_{SF} is greater than b₁, the reliability value may be 1. When the vehicle acceleration is greater than a₁ and Δ_{SF} is greater than b₂ and smaller than b₁, the reliability value may be 2. When the vehicle acceleration is greater than a₁ and Δ_{SF} is smaller than b₂, the reliability value may be 3.

When the vehicle acceleration is greater than a₂ and smaller than a₁, and Δ_{SF} is greater than b₁, the reliability value may be 2. When the vehicle acceleration is greater than a₂ and smaller than a₁, and Δ_{SF} is greater than b₂ and smaller than b₁, the reliability value may be 3. When the vehicle acceleration is greater than a₂ and smaller than a₁, and Δ_{SF} is smaller than b₂, the reliability value may be 4.

When the vehicle acceleration is smaller than a₂ and Δ_{SF} is greater than b₁, the reliability value may be 3. When the vehicle acceleration is smaller than a₂ and Δ_{SF} is greater than b₂ and smaller than b₁, the reliability value may be 4. When the vehicle acceleration is smaller than a₂ and Δ_{SF} is smaller than b₂, the reliability value may be 5.

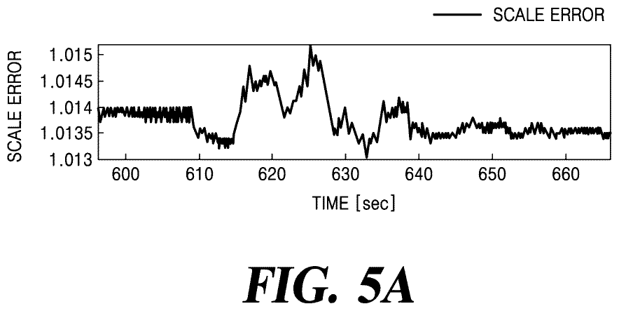

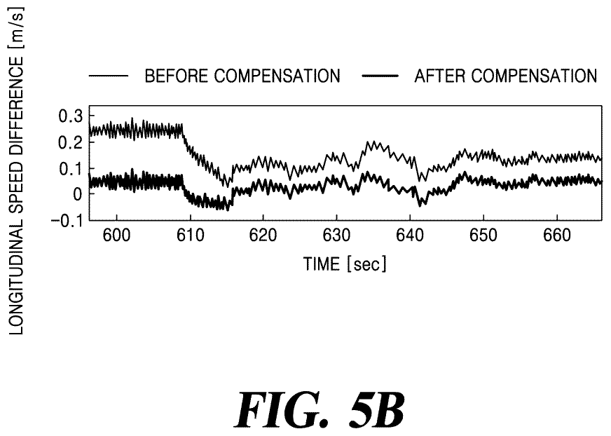

Referring now to FIGS. 5A and 5B, diagrams illustrating the scale error over time and a difference in dependency with respect to a reference vehicle before compensation and a difference in dependency with respect to a reference vehicle after compensation over time are illustratively depicted, in accordance with exemplary embodiments of the present disclosure.

Referring to FIGS. 5A and 5B, FIG. 5A illustrates the scale error estimated in real time by the scale error estimation apparatus 10 over time. This scale error may be a value estimated using only sensing values acquired by sensors inside the vehicle without using GPS information, or the like.

FIG. 5B illustrates the difference in the dependency before compensating for the scale error estimated in real time over time. Here, the difference in the dependency is the difference between the dependency of the reference vehicle and the dependency before compensating for the scale error estimated in real time. In addition, FIG. 5B illustrates the difference in the difference after compensating for the scale error estimated in real time over time. Here, the difference in the dependency is the difference between the dependency of the reference vehicle and the dependency after compensating for the scale error estimated in real time. It can be confirmed that the difference in the dependency before compensating for the scale error estimated in real time is larger than the difference in the dependency after compensating for the scale error estimated in real time.

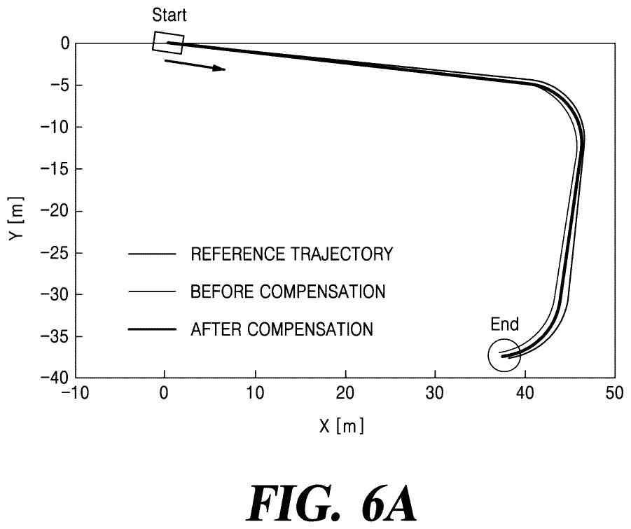

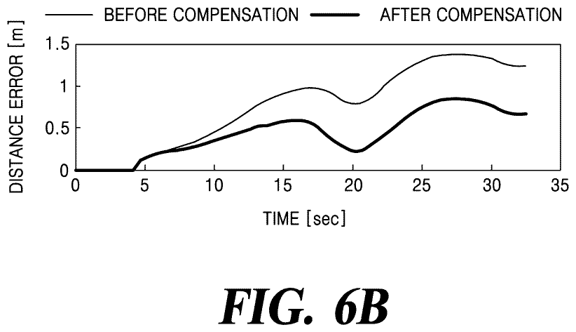

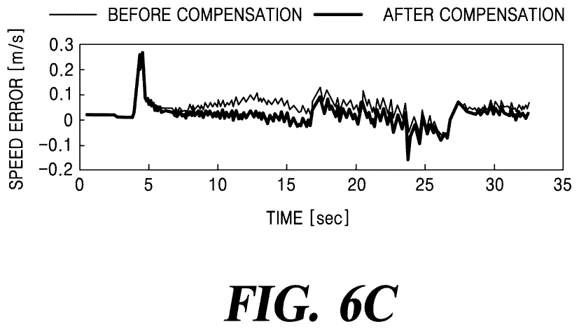

Referring now to FIGS. 6A, 6B, and 6C, diagrams illustrating a trajectory of the vehicle before compensation and a trajectory of the vehicle after compensation, a distance error before compensation and a distance error after compensation over time, and a speed error before compensation and a speed error after compensation over time are illustratively depicted, in accordance with exemplary embodiments of the present disclosure.

Referring to FIG. 6A, a reference trajectory, which is the actual moving trajectory of the reference vehicle, a moving trajectory of the vehicle before compensating for the scale error estimated in real time, and a moving trajectory of the vehicle after compensating for the scale error estimated in real time may be confirmed. Here, the moving trajectory of the vehicle may be expressed by an easting & northing (ENU) coordinate system. It can be confirmed that the moving trajectory of the vehicle after compensating for the scale error estimated in real time has a moving trajectory more similar to the reference trajectory than the moving trajectory of the vehicle before compensating for the scale error estimated in real time. Accordingly, by compensating for the scale error estimated in real time, the positioning error due to the drift of the vehicle in the positioning by dead reckoning (DR) can be improved.

Referring to FIG. 6B, the distance error before compensating for the scale error estimated in real time over time can be confirmed. Here, the distance error may be the difference between a real-time actual location of the reference vehicle and a real-time location of the vehicle before compensating for the scale error estimated in real time. In addition, the distance error after compensating for the scale error estimated in real time over time may be confirmed. Here, the distance error may be the difference between the real-time actual location of the reference vehicle and the real-time location of the vehicle after compensating for the scale error estimated in real time. It can be confirmed that the distance error after compensating for the scale error estimated in real time is smaller than the distance error before compensating for the scale error estimated in real time.

Referring to FIG. 6C, a speed error before compensating for the scale error estimated in real time over time can be confirmed. Here, the speed error may be the difference between the real-time actual speed of the reference vehicle and the real-time speed of the vehicle before compensating for the scale error estimated in real time. In addition, the speed error after compensating for a scale error estimated in real time over time can be confirmed. Here, the speed error may be the difference between the real-time actual speed of the reference vehicle and the real-time speed of the vehicle after compensating for the scale error estimated in real time. It can be confirmed that the speed error after compensating for the scale error estimated in real time is smaller than the speed error before compensating for the scale error estimated in real time.

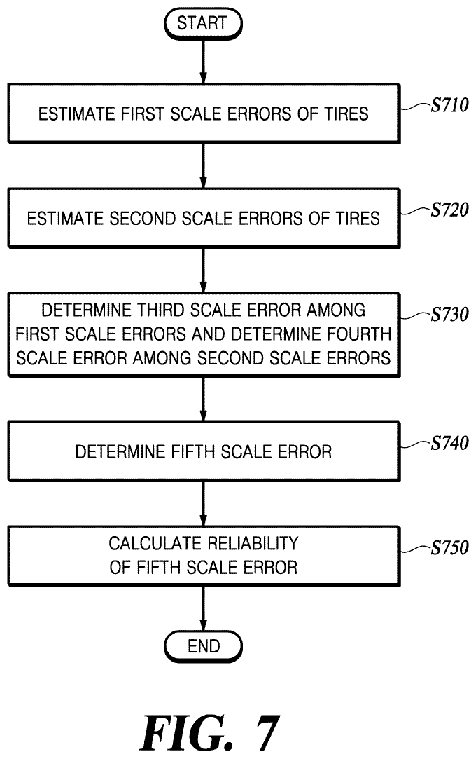

Referring now to FIG. 7, a flowchart illustrating a method for estimating the scale error of a vehicle speed is illustratively depicted, in accordance with an exemplary embodiment of the present disclosure.

Referring to FIG. 7, the data-driven scale error estimation unit 110 may be configured to estimate first scale errors of the tires using wheel speeds and pressures of wheels of the vehicle (S710). The first scale errors of tires may be estimated using a lookup table. The lookup table may comprise predefined data on wheel speeds and pressures of wheels.

The model-based scale error estimation unit 120 may be configured to estimate second scale errors of the tires using the wheel speed of the wheels, the pressure of the wheels, and the IMU measurement information (S720). The process of estimating the second scale errors of the tires may comprise a process of calculating the rotational influences of the tires using the wheel speeds of the wheels and the parameters of the tires, a process of calculating the vertical stiffness of the tires using the pressures of the wheels and the parameters of the tires, a process of calculating the vertical force of the tires using the IMU measurement information and the specification information of the vehicle, a process of calculating first tire effective radii of the tires using the rotational influence of the tires, the vertical stiffness of the tires, the vertical forces of the tires, the parameters of the tires, and the specification information of the vehicle, and a process of calculating the second scale errors of the tires using the first tire effective radii of the tires and the second tire effective radii of the tires acquired by the ESC.

The scale error determination unit 130 may be configured to determine a third scale error among the first scale errors of the tires using the wheel speeds of the wheels, and may be configured to determine a fourth scale error among the second scale errors of the tires using the wheel speeds of the wheels (S730). The scale error determination unit 130 may be configured to determine a fifth scale error using the third scale error and fourth scale error (S740). The process of determining the fifth scale error may comprise a process of calculating the gain using the acceleration of the vehicle and the first threshold value and the second threshold value, and a process of determining the fifth scale error using the third scale error and the fourth scale error based on the gain.

The first threshold value and the second threshold value may be any predefined value. The first threshold value may be smaller than the second threshold value. When the acceleration of the vehicle is smaller than or equal to the first threshold value, the gain may be calculated as 0. When the acceleration of the vehicle is larger than the first threshold value and smaller than the second threshold value, the gain may be calculated linearly. When the acceleration of the vehicle is larger than or equal to the second threshold value, the gain may be calculated as 1. The reliability calculation unit 140 may be configured to calculate the reliability of the fifth scale error by using the difference between the third scale error and the fourth scale error and the acceleration of the vehicle (S750).

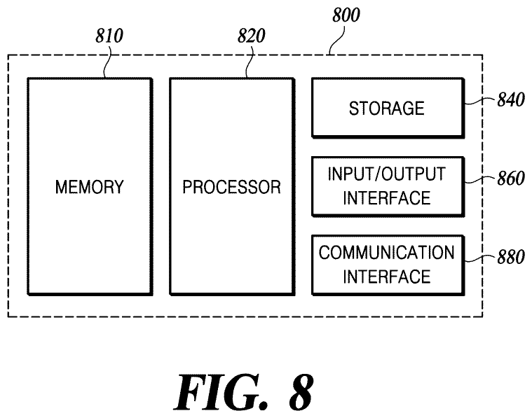

Referring now to FIG. 8, a block diagram schematically illustrating an exemplary computing device that may be used to implement a method is illustratively depicted, in accordance with an exemplary embodiment of the present disclosure.

The computing device 800 may comprise some or all of a memory 810, a processor 820, a storage 840, an input/output interface 860, and a communication interface 880. The computing device 800 may structurally and/or functionally comprise at least a part of the scale error estimation apparatus 10. The computing device 800 may comprise a stationary computing device such as a desktop computer, a server, an AI accelerator, or the like, as well as a portable computing device such as a laptop computer, a smart phone, or the like.

The memory 810 may be configured to store a program that, when implemented by the processor, are configured to cause the processor 820 to perform a method or operation according to various embodiments of the present disclosure. For example, the program may comprise a plurality of instructions executable by the processor 820, and the method illustrated in FIG. 7 may be performed by executing the plurality of instructions by the processor 820.

The memory 810 may comprise a single memory or a plurality of memories. In this case, information required to perform a method or operation according to various embodiments of the present disclosure may be stored in a single memory or divided and stored in multiple memories. When the memory 810 comprises a plurality of memories, the plurality of memories may be physically separated.

The memory 810 may comprise at least one of volatile memory and nonvolatile memory. The volatile memory may comprise a static random-access memory (SRAM) or a dynamic random-access memory (DRAM), and the nonvolatile memory may comprise flash memory.

The processor 820 may comprise at least one core capable of executing at least one instruction. The processor 820 may be configured to execute instructions stored in the memory 810. The processor 820 may comprise a single processor or a plurality of processors.

The storage 840 may be configured to maintain stored data even when power supplied to the computing device 800 is cut off. For example, the storage 840 may comprise nonvolatile memory, and may comprise storage media such as magnetic tape, optical disk, or magnetic disk.

A program stored in the storage 840 may be loaded into the memory 810 before being executed by the processor 820. The storage 840 may be configured to store a file written in a programming language, and a program generated from the file by a compiler or the like may be loaded into the memory 810. The storage 840 may be configured to store data to be processed by the processor 820 and/or data processed by the processor 820.

The input/output interface 860 may comprise input devices such as a keyboard, a mouse, or the like, and may comprise output devices such as a display device, a printer, or the like. A user may trigger execution of a program by the processor 820 and/or check the processing result of the processor 820 through the input/output interface.

The communication interface 880 may be configured to provide access to an external network. For example, the computing device 800 may be configured to communicate with other devices via the communication interface 880.

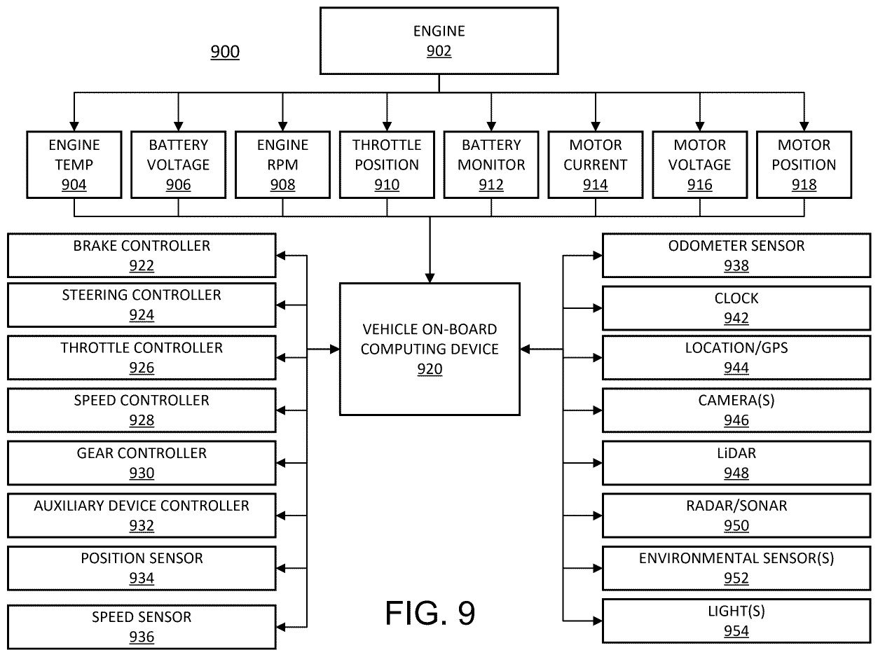

Referring now to FIG. 9, an example vehicle system architecture 900 for a vehicle is provided, in accordance with an exemplary embodiment of the present disclosure. The following discussion of vehicle system architecture 900 is sufficient for understanding one or more components of the vehicle described herein.

As shown in FIG. 9, the vehicle system architecture 900 may comprise an engine, motor or propulsive device 902 and various sensors 904-918 for measuring various parameters of the vehicle system architecture 900, such as, but not limited to, those of the vehicle snapshot described above. In gas-powered or hybrid vehicles having a fuel-powered engine, the sensors 904-918 may comprise, for example, an engine temperature sensor 904, a battery voltage sensor 906, an engine Rotations Per Minute (RPM) sensor 908, and/or a throttle position sensor 910. If the vehicle is an electric or hybrid vehicle, then the vehicle may comprise an electric motor, and accordingly may comprise sensors such as a battery monitoring system 912 (to measure current, voltage and/or temperature of the battery), motor current 914 and voltage 916 sensors, and motor position sensors such as resolvers and encoders 918.

Operational parameter sensors that are common to both types of vehicles may comprise, for example: a position sensor 934 such as an accelerometer, gyroscope and/or inertial measurement unit; a speed sensor 936; and/or an odometer sensor 938. The vehicle system architecture 900 also may comprise a clock 942 that the system uses to determine vehicle time and/or date during operation. The clock 942 may be encoded into the vehicle on-board computing device 920, it may be a separate device, or multiple clocks may be available.

The vehicle system architecture 900 may comprise various sensors that operate to gather information about the environment in which the vehicle is traveling. These sensors may comprise, for example: a location sensor 944 (for example, a Global Positioning System (GPS) device); object detection sensors such as one or more cameras 946; a LiDAR sensor system 948; and/or a radar and/or a sonar system 950. The sensors may comprise environmental sensors 952 such as, e.g., a humidity sensor, a precipitation sensor, a light sensor, and/or ambient temperature sensor. The object detection sensors may be configured to enable the vehicle system architecture 900 to detect objects that are within a given distance range of the vehicle in any direction, while the environmental sensors 952 may be configured to collect data about environmental conditions within the vehicle's area of travel. According to an exemplary embodiment, the vehicle system architecture 900 may comprise one or more lights 954 (e.g., headlights, flood lights, flashlights, etc.).

During operations, information may be communicated from the sensors to an on-board computing device 920 (e.g., computing device 800). The on-board computing device 920 may be configured to analyze the data captured by the sensors and/or data received from data providers and may be configured to optionally control operations of the vehicle system architecture 900 based on results of the analysis. For example, the on-board computing device 920 may be configured to control: braking via a brake controller 922; direction via a steering controller 924; speed and acceleration via a throttle controller 926 (in a gas-powered vehicle) or a motor speed controller 928 (such as a current level controller in an electric vehicle); a differential gear controller 930 (in vehicles with transmissions); and/or other controllers. The brake controller 922 may comprise a pedal effort sensor, pedal effort sensor, and/or simulator temperature sensor, as described herein.

Geographic location information may be communicated from the location sensor 944 to the on-board computing device 920, which may then access a map of the environment that corresponds to the location information to determine known fixed features of the environment such as streets, buildings, stop signs and/or stop/go signals. Captured images from the cameras 946 and/or object detection information captured from sensors such as LiDAR 948 may be communicated from those sensors to the on-board computing device 920. The object detection information and/or captured images may be processed by the on-board computing device 920 to detect objects in proximity to the vehicle. Any known or to be known technique for making an object detection based on sensor data and/or captured images may be used in the embodiments disclosed in this document.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may comprise all types of storage devices on which computer-readable data can be stored. The computer-readable recording medium may be a non-volatile or non-transitory medium such as a read-only memory (ROM), a compact disc ROM (CD-ROM), magnetic tape, a floppy disk, a memory card, a hard disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an description of the technical idea of one embodiment of the present disclosure. In other words, those having ordinary skill in the art to which one embodiment of the present disclosure belongs may appreciate that various modifications and changes can be made without departing from essential features of an embodiment of the present disclosure. In other words, the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claims. Therefore, embodiments of the present disclosure have been described for the sake of brevity and clarity. The scope of the technical idea of the present embodiments is not limited by the illustrations. Accordingly, one of ordinary skill would understand that the scope of the claims is not to be limited by the above explicitly described embodiments but by the claims and equivalents thereof.

What is claimed is:

1. A scale error estimation apparatus comprising:
a computing device, comprising a processor and a memory, wherein the memory is configured to store instructions that, when executed by the processor, are configured to cause the processor to:
estimate first scale errors of tires using:
wheel speeds of wheels of a vehicle; and
pressures of the wheels;
estimate second scale errors of the tires using:
the wheel speeds of the wheels;
the pressures of the wheels; and
inertial measurement unit (IMU) measurement information;
determine:
a third scale error among the first scale errors of the tires using the wheel speeds of the wheels;
a fourth scale error among the second scale errors of the tires using the wheel speeds of the wheels; and
a fifth scale error using the third scale error and the fourth scale error; and
calculate a reliability of the fifth scale error using a difference between the third scale error and the fourth scale error and acceleration of the vehicle.

2. The scale error estimation apparatus of claim 1, wherein the computing device is further configured to estimate the first scale errors of the tires using a lookup table.

3. The scale error estimation apparatus of claim 2, wherein the lookup table comprises predetermined data on the wheel speeds of the wheels and the pressures of the wheels.

4. The scale error estimation apparatus of claim 1, wherein the computing device is further configured to:
calculate rotational influences of the tires using the wheel speeds of the wheels and parameters of the tires; and
calculate a vertical stiffness of the tires using the pressures of the wheels and the parameters of the tires.

5. The scale error estimation apparatus of claim 4, wherein the computing device is further configured to calculate a vertical force of the tires using the IMU measurement information and specification information of the vehicle.

6. The scale error estimation apparatus of claim 5, wherein the computing device is further configured to calculate a first tire effective radiuss using the rotational influences of the tires, the vertical stiffness of the tires, the vertical forces of the tires, the parameters of the tires, and the specification information of the vehicle.

7. The scale error estimation apparatus of claim 6, wherein the computing device is further configured to calculate:
the second scale error of the tires using the first tire effective radiuss; and
a second tire effective radiuss obtained by electronic stability control (ESC).

8. The scale error estimation apparatus of claim 1, wherein the computing device is further configured to:
calculate a gain using the acceleration of the vehicle, a first threshold value, and a second threshold value; and
determine the fifth scale error using the third scale error and the fourth scale error based on the gain.

9. The scale error estimation apparatus of claim 8, wherein:
the first threshold value and the second threshold value are predetermined arbitrary values, and
the first threshold value is smaller than the second threshold value.

10. The scale error estimation apparatus of claim 5, wherein the computing device is further configured to:
calculate the gain as 0 when the acceleration of the vehicle is smaller than or equal to the first threshold value;
calculate the gain linearly when the acceleration of the vehicle is greater than the first threshold value and smaller than the second threshold value; and
calculate the gain as 1 when the acceleration of the vehicle is greater than or equal to the second threshold value.

11. A method performed by a scale error estimation apparatus, the method comprising:
using a computing device comprising a processor and a memory:
estimating first scale errors of tires using:
wheel speeds of wheels of a vehicle; and
pressures of the wheels;
estimating second scale errors of the tires using:
the wheel speeds of the wheels;
the pressures of the wheels; and
inertial measurement unit (IMU) measurement information;
determining:
a third scale error among the first scale errors of the tires using the wheel speeds of the wheels;
a fourth scale error among the second scale errors of the tires using the wheel speeds of the wheels; and
a fifth scale error using the third scale error and the fourth scale error; and
calculating a reliability of the fifth scale error using a difference between the third scale error and the fourth scale error and acceleration of the vehicle.

12. The method of claim 11, wherein the estimating the first scale errors of the tires comprises estimating the first scale errors of the tires using a lookup table.

13. The method of claim 12, wherein the lookup table comprises predetermined data on the wheel speeds of the wheels and the pressures of the wheels.

14. The method of claim 11, wherein the estimating the second scale errors of the tires comprises:
calculating rotational influences of the tires using the wheel speeds of the wheels and parameters of the tires; and
calculating a vertical stiffness of the tires using the pressures of the wheels and the parameters of the tires.

15. The method of claim 14, wherein the estimating the second scale errors of the tires comprises calculating a vertical force of the tires using the IMU measurement information and specification information of the vehicle.

16. The method of claim 15, wherein the estimating the second scale errors of the tires comprises:
calculating a first tire effective radiuss using the rotational influences of the tires, the vertical stiffness of the tires, the vertical forces of the tires, the parameters of the tires, and the specification information of the vehicle; and
calculating the second scale errors of the tires using the first tire effective radiuss and a second tire effective radiuss obtained by electronic stability control (ESC).

17. The method of claim 11, wherein the determining the fifth scale error comprises:
calculating a gain using the acceleration of the vehicle, a first threshold value, and a second threshold value; and
determining the fifth scale error using the third scale error and the fourth scale error based on the gain.

18. The method of claim 17, wherein:
the first threshold value and the second threshold value are predetermined arbitrary values, and
the first threshold value is smaller than the second threshold value.

19. The method of claim 18, wherein:
the gain is calculated as 0 when the acceleration of the vehicle is smaller than or equal to the first threshold value,
the gain is calculated linearly when the acceleration of the vehicle is greater than the first threshold value and smaller than the second threshold value, and
the gain is calculated as 1 when the acceleration of the vehicle is greater than or equal to the second threshold value.

20. A scale error estimation apparatus comprising:
a vehicle; and
a computing device, coupled to the vehicle, comprising a processor and a memory, wherein the memory is configured to store instructions that, when executed by the processor, are configured to cause the processor to:
estimate first scale errors of tires using:
wheel speeds of wheels of the vehicle; and
pressures of the wheels;
estimate second scale errors of the tires using:
the wheel speeds of the wheels;
the pressures of the wheels; and
inertial measurement unit (IMU) measurement information;
determine:
a third scale error among the first scale errors of the tires using the wheel speeds of the wheels;
a fourth scale error among the second scale errors of the tires using the wheel speeds of the wheels; and
a fifth scale error using the third scale error and the fourth scale error; and
calculate a reliability of the fifth scale error using a difference between the third scale error and the fourth scale error and acceleration of the vehicle.
